(19) United States
(12) Patent Application Publication
(10) Pub. No.: US 2020/0368884 A1
(43) Pub. Date: Nov. 26, 2020

(54) Screw Mount and Locking Device

(71) Applicant: Robert Rivera, Edinburg, TX (US)

(72) Inventor: Robert Rivera, Edinburg, TX (US)

(21) Appl. No.: 16/880,316

(22) Filed: May 21, 2020

Related U.S. Application Data
(60) Provisional application No. 62/851,186, filed on May 22, 2019.

(51) Int. Cl. B25B 23/10

(52) U.S. Cl. CPC B25B 23/101

(57) ABSTRACT

The present invention relates to an apparatus to hold a screw on a screw driver. The device comprises a ring base, a spring, and a hook. The base is secured to the shaft of a screw driver with a locking screw. The hook, via a spring, is connected to the base. The hook wraps around a head of a screw and the spring compresses the screw against the screw driver tip.

### CROSS-REFERENCES TO RELATED APPLICATIONS

This application claims the benefit of U.S. Provisional Application Ser. No. 62/851,186 filed May 22, 2019 entitled Mounting Screw and Locking Device which is incorporated by reference herein.

### STATEMENT REGARDING FEDERALLY SPONSORED RESEARCH OR DEVELOPMENT

Not applicable.

### BACKGROUND OF THE INVENTION

### Field of the Invention

This invention relates to an apparatus to hold a screw on a screw driver.

### 2. BACKGROUND OF THE RELATED ART

Other products on the market utilize a tweezer like device to secure the screw to the screwdriver. This results in an unstable mount as there is no spring to provide additional tension. The prior art utilizes friction fit or clamping to hold the screw. These options do not utilized a compression force that pushes the screw against the tip of the screw driver. Further, other products are not easily disengaged from the screw. This results in difficulty utilizing the screw driver in narrow spaces as the screw mount itself may interfere. Finally, other products have a cumbersome process to attach the screw to the device which requires excessive time to take the device off the screw and attach to the next. A need exists for a device that is stable, easy to engage and disengage, and easy to move out of the way.

### SUMMARY OF THE INVENTION

The present device utilizes a base, a spring, and a hook to hold a screw onto the tip of a screw driver. The base is secured to the shaft of a screw driver with a locking screw. The spring is connected to the base and to a hook. A screw is placed onto the hook and the spring is stretched to allow the screw to fit onto the screw driver tip. The spring then compresses holding the screw against the screwdriver tip. The user may then rotate the screwdriver while holding onto the screw mount device to get the screw started. Once started, the user then disengages the hook from the screw by pulling the hook against the compression force of the spring. The hook may then be stored on the base.

### BRIEF DESCRIPTION OF THE DRAWINGS

FIG. 1 is a perspective view of an embodiment of the present invention.

FIG. 2 is a top down view of an embodiment of the present invention.

FIG. 3 is a side view of the base ring of the present invention.

FIG. 4 is a perspective view of the base ring of the present invention.

FIG. 5 is a perspective view of the hook of the present invention.

FIG. 6 is a side view of an embodiment of the present invention attached to a screw driver.

FIG. 7 is a side view of an embodiment of the present invention attached to a screw driver with a screw being placed.

FIG. 8 is a side view of an embodiment of the present invention attached to a screw driver with a screw placed.

FIG. 9 is a side view of an embodiment of the present invention attached to a screw driver in the stored position.

### DETAILED DESCRIPTION

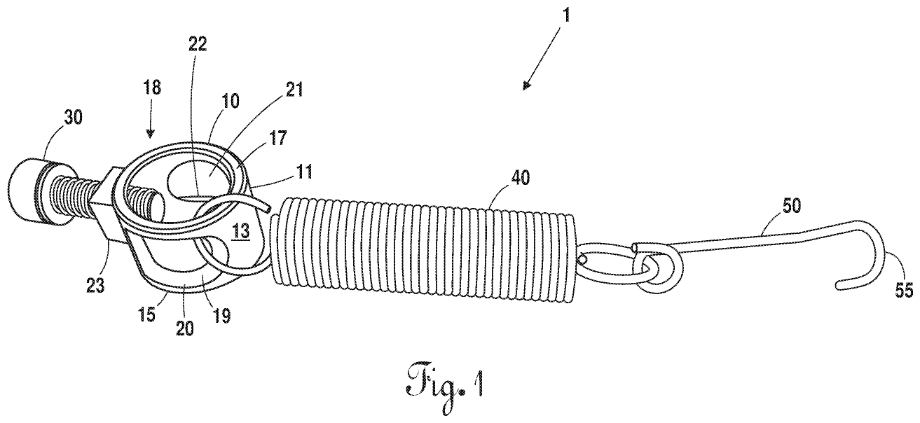

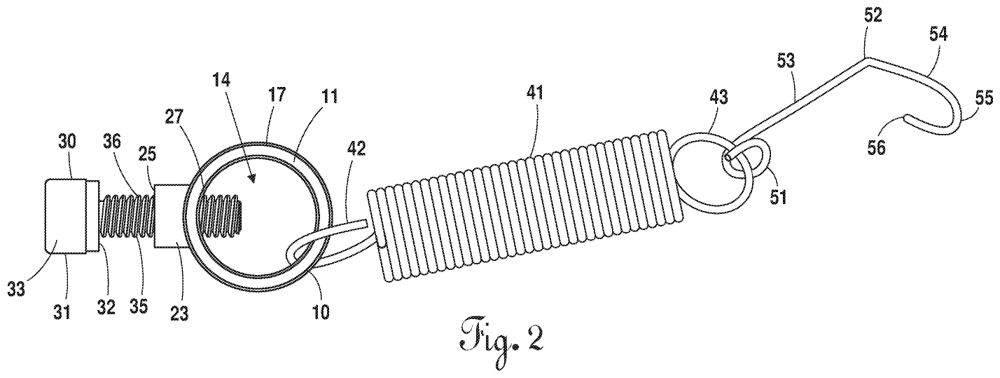

As seen in FIGS. 1-2, the screw mount device 1 comprises a ring base 10, a locking screw 30, a spring 40, and a hook 50.

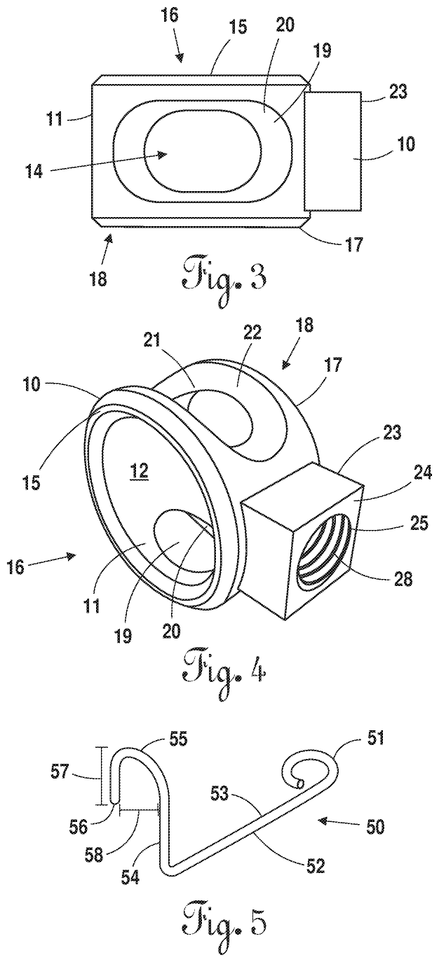

The ring base 10, shown in more detail in FIGS. 3 and 4, comprises a cylindrical sidewall 11, having an interior face 12 and an exterior face 13, defining a cavity 14. A beveled first rim 15 defines a first open end 16 and a beveled second rim 17 defines a second open end 18. The cylindrical sidewall 11 has a first cutout 19 having a beveled edge 20 and a second cutout 21 having a beveled edge 22 opposite the first cutout 19.

A square projection 23 extends from exterior face 13 of the cylindrical sidewall 11 between the first cutout 19 and second cutout 21. The square projection 23 has a flat top face 24 with an opening 25. A channel 26 extends from the opening 25 through the square projection 23 and through the cylindrical sidewall 11 and terminates at opening 27. The interior surface of channel 26 is threaded 28. In the preferred embodiment the square projection 23 and the ring base 10 are integral and constructed of metal or other suitably hard material. In the preferred embodiment the projection 23 is square but other shapes could be utilized.

The locking screw 30 comprises a head 31 and a shaft 35. The head 31 may a flat bottom surface 32 and a cylindrical sidewall 33 having a textured exterior surface. The head may further have a drive of any shape including but not limited to flat, Phillips, hex or torx. The shaft 35 has threads 36 on the exterior. The locking screw 30 is sized to mate with the threads 28 of the ring base 10. In an alternative embodiment the pin may not have threads and have frictional fit within the channel.

The spring 40 comprises a spring extension body 41, first connection loop 42, and second connection loop 43.

As seen in more detail in FIG. 5, the hook 50 comprises a connection loop 51, a shank 52, and bend 55 that terminates at a flat point 56. The shank 52 further comprises a straight portion 53 and an angled portion 54. In the preferred embodiment the angled portion 54 extends approximately 90 degrees from the straight portion 43. The bend 55, having a throat 57 and gap 58, extends from the angled portion 54 and terminates at point 56. The hook 50 is generally rod shaped and thin. The throat 57 and gap 58 of the hook 50 are of such dimension to fit under the head of and around the shaft of most screws.

In the preferred embodiment, the locking screw 30 is threaded into the ring base 10 through opening 25. The first connection loop 42 of the spring 40 is secured to the ring base 10 by the portion of the cylindrical sidewall 11 between the first cutout 19 and the beveled second rim 17. Alternatively, the connection loop 42 of the spring 40 may be connected to the portion of the cylindrical sidewall 11 between the second cutout 21 and the beveled second rim 17. The second connection loop 43 of the spring 41 is connected to the connection loop 51 of the hook 50.

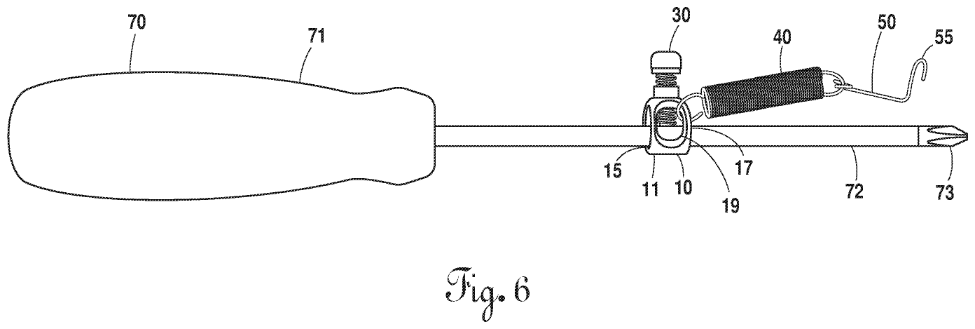

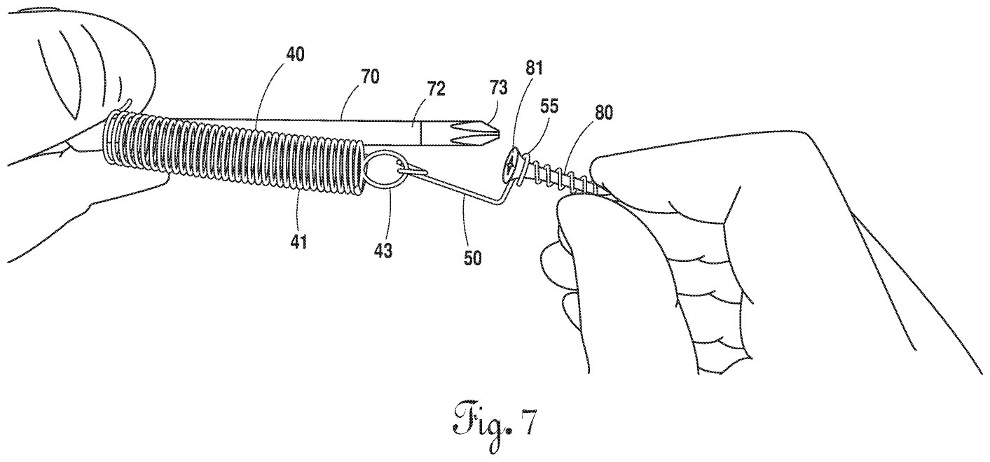

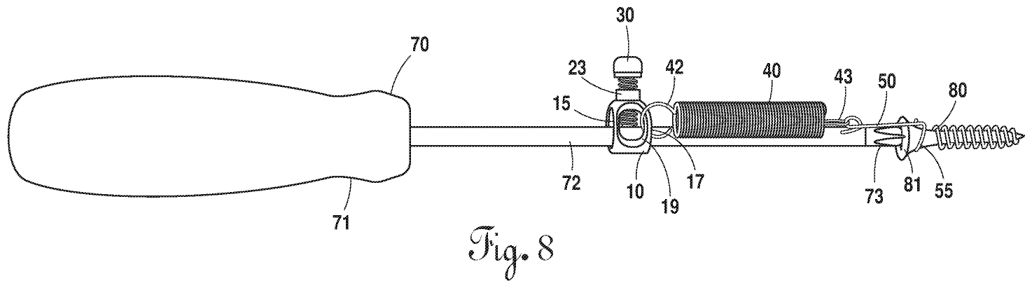

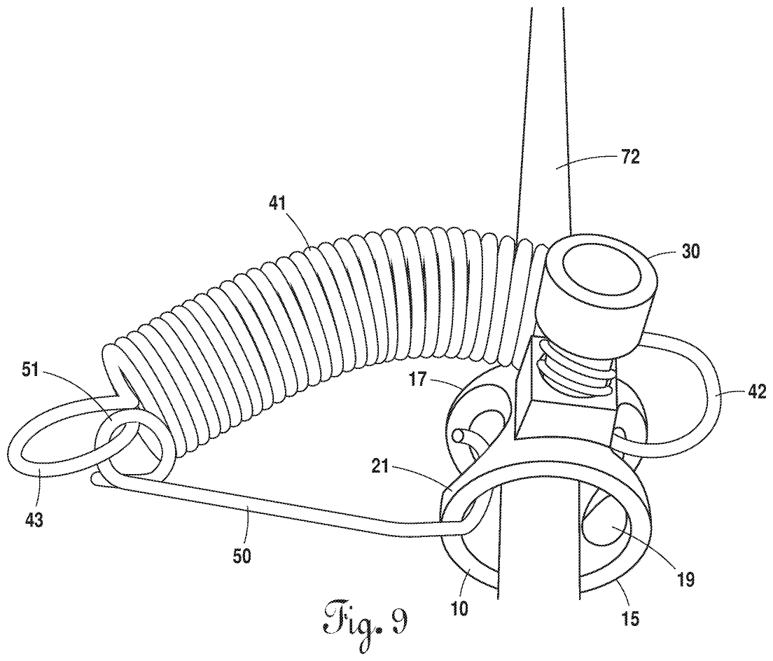

In operation, as seen in FIGS. 6-8, the shaft 72 of a screw driver 70 is inserted into the ring base 10 through the first open end 16 and out the second open end 18. The size of the cavity 14 of the ring base 10 permits use with any number of screwdrivers 70 having a variety of shaft sizes and designs including round, square, and other polygonal shapes. Once the ring base 10 is positioned on the shaft 72, the bend 55 of the hook 50 is approximately half an inch or quarter inch below the screw driver tip 73, the locking screw 30 is tightened until the ring base 10 cannot slide along the shaft. A screw 80 is them placed on the hook 50 with the bend 55 wrapping below the head 81 of the screw 80. Once secure, the screw 80 is pulled beyond the screw driver tip 73 which causes the spring extension body 41 to stretch. The head 81 of the screw 80 is then engaged with the screw driver tip 73. The spring 40 pulls the screw 80 tight onto the screwdriver 70. Preferably the spring 40 and straight portion 53 of the shank 52 should be generally in a straight line and parallel as seen in FIG. 8. An incorrect mount twists the hook 50 around the shaft 71 and is less secure.

The user then twists the screw mount device 1 to start the screw 80 in the desired location. The twisting of the screw mount device 1 causes the shaft 72 of the screwdriver 70 to rotate. Once the screw 80 is started within the hole, the hook 50 is pulled away from the head 81 of the screw 80 and removed. Once the screw mount device 1 has been used to secure the screws, the user will set the screw mount device 1 in the locked position by anchoring the bend 55 of the hook 50 to the beveled first rim 15 as seen in FIG. 9. This will allow the user to continue working without interference from the screw mount device 1.

Each beveled service is intended to serve as a ramp to allow the connections to be made more smoothly such as insertion of the first connection loop 42 to within the first cutout 19. Additionally, the beveled surfaces help prevent the screw mount device 1 from catching on other surfaces.

In alternative embodiment the ring base may not be ring and instead have angled walls. The size of the first and second cutouts are designed to reduce the weight of the base but also allow the spring to move along the rim of the base.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. It will be understood by one of ordinary skill in the art that numerous variations will be possible to the disclosed embodiments without going outside the scope of the invention as disclosed in the claims.

I claim:

1. A screw mount device comprising:
a base having sidewall, a first opening, a second opening opposite the first opening, and third opening perpendicular to the first opening;
a locking nut threadably engaged with the base through the third opening;
a hook; and
a spring having a first end connected to the base and a second end connected to the hook.

2. A screw mount device according to claim 1 wherein the hook further comprises a shank having a straight portion and an angled portion and a bend connected to the angled portion.

3. A screw mount device according to claim 1 wherein the base further comprises a first cutout within the sidewall and a second cutout in the sidewall opposite from the first cutout.

4. A screw mount device according to claim 3 wherein the first cutout and second cutout each have a beveled edge.

5. A screw mount device according to claim 3 wherein the first end of the spring connects to the base at the first cutout.

6. A screw mount device comprising:
a ring base having cylindrical sidewall, a first opening, and a second opening opposite the first opening;
a hook; and
a spring having a first end connected to the base and a second end connected to the hook.

7. A screw mount device according to claim 6 wherein a third opening is positioned through the sidewall.

8. A screw mount device according to claim 7 further comprising a locking pin sized to fin within the third opening.

9. A screw mount device according to claim 8 wherein the third opening and locking pin are threaded.

10. A screw mount device according to claim 6 further comprises a shank having a straight portion and an angled portion and a bend connected to the angled portion.

11. A screw mount device according to claim 6 wherein the hook further comprises a shank having a straight portion and an angled portion and a bend connected to the angled portion.

12. A screw mount device according to claim 6 wherein the base further comprises a first cutout within the sidewall and a second cutout in the sidewall opposite from the first cutout.

13. A screw mount device according to claim 12 wherein the first cutout and second cutout each have a beveled edge.

14. A screw mount device according to claim 12 wherein the first end of the spring connects to the base at the first cutout.
